(19) United States
(12) Patent Application Publication
(10) Pub. No.: US 2026/0110441 A1
(43) Pub. Date: Apr. 23, 2026

(54) METHOD FOR OPERATING A HEATING MEANS OF A COOKING APPLIANCE

(71) Applicant: Miele & Cie. KG, Gütersloh (DE)

(72) Inventor: Volker Ennen, Bünde (DE)

(21) Appl. No.: 19/168,337

(22) PCT Filed: Apr. 2, 2024
(86) PCT No.: PCT/EP2024/058841

§ 371 Date: Sep. 24, 2025

(30) Foreign Application Priority Data
Apr. 4, 2023 (BE) BE2023/5260

(51) Int. Cl. F24C 15/18; A47J 39/02; F24C 7/06; H05B 6/12; H05B 6/46; H05B 11/00

(52) U.S. Cl. CPC F24C 15/18; A47J 39/02; F24C 7/067; H05B 6/129; H05B 6/46; H05B 11/00

(57) ABSTRACT

A method for operating a heating means of a cooking appliance includes: the heating means is made of a conductive material. The heating means is arranged opposite a further conductive element of the cooking appliance so that a cooking chamber of the cooking appliance extends between the heating means and the further conductive element. In an alternating manner, an alternating voltage relative to the further conductive element is applied to or generated on the heating means in order to generate an electromagnetic alternating field which passes through the cooking chamber, and a current is applied to or generated on the heating means in order to heat the heating means by ohmic losses.

### CROSS-REFERENCE TO PRIOR APPLICATIONS

This application is a U.S. National Phase application under 35 U.S.C. §371 of International Application No. PCT/EP2024/058841, filed on Apr. 2, 2024, and claims benefit to Belgian Patent Application No. BE 2023/5260, filed on Apr. 4, 2023. The International Application was published in German on Oct. 10, 2024 as WO/2024/208782 under PCT Article 21(2).

### FIELD

The invention relates to a method for operating a heating means of a cooking appliance, wherein the heating means is made of a conductive material and wherein the heating means is arranged opposite a further conductive element of the cooking appliance so that a cooking chamber of the cooking appliance extends between the heating means and the further conductive element. Furthermore, the invention relates to a corresponding cooking appliance, which is configured to carry out such a method.

### BACKGROUND

A wide variety of cooking appliances such as ovens, steamers, microwaves, stoves, warming drawers and the like are known from the prior art, often combining a plurality of cooking functions in individual cooking appliances. In combined cooking appliances, separate heating means are provided for each function, which must each be accommodated in the limited space available, making the construction of the cooking appliance correspondingly complex and expensive.

EP 3 701 769 B1, for example, discloses an oven with a plurality of functions, including multiple low-frequency generating devices.

### SUMMARY

In an embodiment, the present invention provides a method for operating a heating means of a cooking appliance, wherein the heating means is made of a conductive material, wherein the heating means is arranged opposite a further conductive element of the cooking appliance so that a cooking chamber of the cooking appliance extends between the heating means and the further conductive element, the method comprising: in an alternating manner, an alternating voltage relative to the further conductive element is applied to or generated on the heating means in order to generate an electromagnetic alternating field which passes through the cooking chamber, and a current is applied to or generated on the heating means in order to heat the heating means by ohmic losses.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1a is a schematic cross-sectional view of a cooking appliance according to the second aspect of the invention in one embodiment;

FIG. 1b is a schematic cross-sectional view of a cooking appliance according to the first aspect of the invention in a further embodiment; and

FIG. 2 is a flow diagram of a method according to the first aspect of the invention.

### DETAILED DESCRIPTION

In an embodiment, the present invention provides a cooking appliance with a wide range of functions and minimal space requirements.

According to a first aspect of the invention, a method for operating a heating means of a cooking appliance is provided, wherein the heating means is made of a conductive material and wherein the heating means is arranged opposite a further conductive element of the cooking appliance so that a cooking chamber of the cooking appliance extends between the heating means and the further conductive element, wherein, in an alternating manner, an alternating voltage is applied to or generated on the heating means relative to the further conductive element in order to generate an electromagnetic alternating field which passes through the cooking chamber and a current is applied to or generated on the heating means in order to heat the heating means by means of ohmic losses.

A heating means is understood to be a means that is configured to influence the temperature of food. This includes both the transfer of heat between the heating means and the food through heat transfer, in particular thermal radiation and convection, as well as the influencing of the temperature of the food in other ways, in particular by stimulating ionic and/or molecular movement in the food through electromagnetic radiation.

In an embodiment, the method described above therefore comprises the teaching that the heating means is heated, on the one hand, in order to generate radiant heat acting on the food and, on the other hand, is operated in order to generate an electromagnetic alternating field. An electromagnetic alternating field is defined as an electromagnetic field with alternating polarity. Such an electromagnetic alternating field penetrates the food and generates ionic movement as well as rotation of dipolar molecules within it so that the food is heated evenly. A change between generating the alternating field and heating of the heating means by current flow preferably takes place in short succession so that during the time in which the electromagnetic alternating field is generated, no significant cooling of the heating means occurs and a desired heating means temperature can be reached and/or maintained. For example, a change occurs within a few milliseconds to a few seconds.

With the described method, the heating means can provide two functions simultaneously, namely electromagnetic heating and heating by thermal radiation of the food. Both functions are therefore available for simultaneous use in the cooking appliance, with only the heating means and the conductive element, which are required anyway to provide an electromagnetic alternating field, having to be provided. Separate means for generating thermal radiation can thus be dispensed with, thus reducing the number of components in the cooking appliance and the space required for them. It can also be provided that the heating means is only subjected to an alternating voltage relative to the further conductive element in order to generate an electromagnetic alternating field or is only heated by a current applied or generated therein, in order to generate radiant heat, so that the aforementioned functions are also available individually in the cooking appliance. The cooking appliance allows the advantages of the particular functions to be utilized in various cooking methods, while only one means is provided in a space-saving manner.

The frequency of the electromagnetic alternating field is preferably in the range of a few megahertz to a few hundred megahertz, approximately between 1 megahertz and 500 megahertz, particularly preferably in the range of ISM bands, e.g., 6.765 MHz to 6.795 MHz, 13.553 MHz to 13.567 MHz, 25.565 MHz to 27.405 MHz, 40.66 MHz to 40.70 MHz and 433 MHz to 444 MHz. These frequencies allow an electromagnetic alternating field favourable for heating food and are available without a license in many countries.

In one embodiment, the current is generated by applying a voltage between two conductor ends of the heating means, in particular at a frequency of 50 or 60 hertz. A conductor end is, for example, a side or edge of a plate or an end of a wire, in particular a wire formed as a coil. At the proposed frequencies of 50 or 60 hertz, the mains voltage available in conventional power grids can be used, eliminating the need for transformation. Alternatively, the current from a power source may be applied to the heating means or impressed on the heating means.

A second aspect of the invention provides a cooking appliance for cooking food, comprising at least one heating means, wherein the heating means is made of a conductive material and wherein the heating means is arranged opposite a further conductive element of the cooking appliance so that a cooking chamber of the cooking appliance extends between the heating means and the further conductive element, wherein the cooking appliance is configured to carry out a method described above. The cooking appliance can be used to achieve the advantages described above with regard to the method.

Insofar as the cooking appliance is designed for cooking food, cooking in the narrower sense is in particular possible, i.e., increasing the temperature of food to at least a food-specific cooking temperature. However, cooking is also understood to mean influencing the temperature of food in other ways, such as defrosting or keeping food warm.

Preferably, the heating means is designed as a plate or flat coil. Within the meaning of the present disclosure, a plate also comprises an assembly of a plurality of plates that together form a plate-shaped region, for example, in a tile-like assembly with one another. A flat coil is furthermore particularly preferably designed as a meandering coil or helical coil. A plate or flat coil can also comprise a plurality of parts, which in particular act on different regions of the cooking chamber and are particularly preferably controllable independently of one another.

Particularly preferably, the heating means and the further conductive element together form a capacitor, i.e., a corresponding voltage source is connected to the heating element on the one hand and, with opposite polarity, to the further conductive element. In particular, the heating means and the further conductive element are designed as identical parts, for example both as a plate or flat coil.

The cooking appliance is designed, for example, as an oven, a tabletop appliance, a microwave, a steamer or any combination thereof. Particularly preferably, the cooking appliance is designed as a warming drawer assembly. In this case, the described advantages regarding the small installation space requirement are particularly desirable. In principle and as already partially described above, means for providing (additional) functions are provided in or on the cooking appliance in any combination of embodiments, in particular further radiant heat means, means for providing a grill function, means for providing a circulating air heating function, means for providing a microwave function going beyond that described above, means for providing an ultrasonic treatment function, means for providing a steam cooking function, means for providing an evacuation function and/or means for providing a cooling function.

The described exemplary embodiments are merely examples, which can be modified and/or supplemented in a variety of ways within the scope of the claims. Each feature described for a specific exemplary embodiment may be used independently or in combination with other features in any other exemplary embodiment. Each feature described for an exemplary embodiment of a specific claim category may also be used correspondingly in an exemplary embodiment of another claim category.

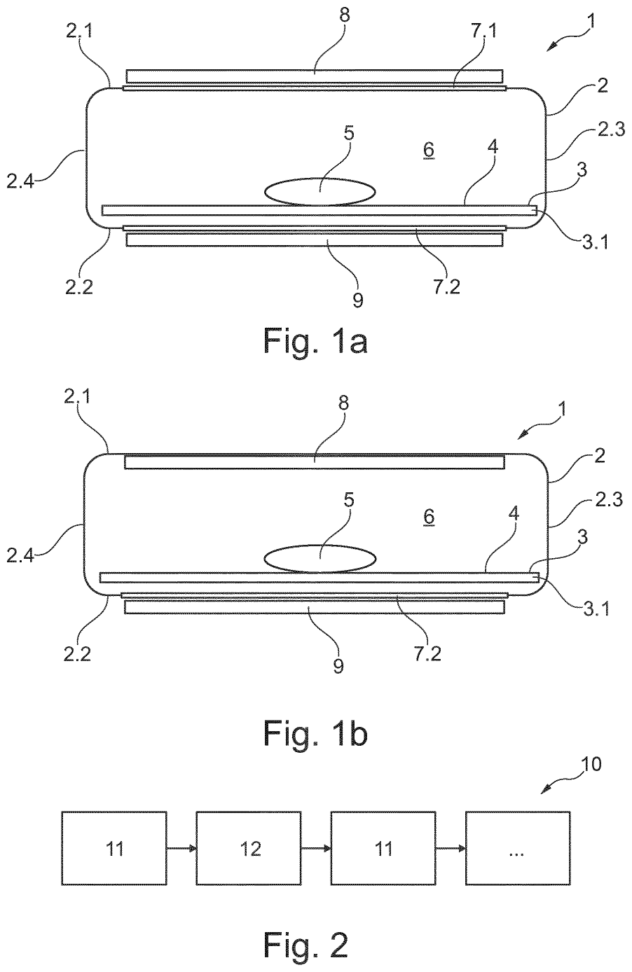

FIG. 1a shows a first embodiment of a cooking appliance 1 in the form of a warming drawer assembly in a highly schematic lateral cross-sectional view. The cooking appliance 1 comprises a housing 2, which is formed, for example, in a kitchen cabinet and has an upper wall 2.1, a lower wall 2.2, a right wall 2.3 and a left wall 2.4. In the housing 2, a drawer 3 is arranged so as to be movable on guide means, only a base 3.1 of said drawer being shown in the schematic view. The housing 2 and the drawer 3 together form a cooking chamber 6, with the base 3.1 forming a placement area 4 for food 5 located in the cooking chamber 6.

The upper wall 2.1 of the housing 2 is formed from glass in a central region 7.1, wherein a heating means 8 is arranged outside the housing 2 in alignment with this central region 7.1 in order, on the one hand, to generate an electromagnetic alternating field which passes through the cooking chamber 6 and in order, on the other hand, to emit heat radiation to the food 5. Both the alternating field and the thermal radiation can penetrate the glass of the central region 71 largely without resistance. The heating means 8 is designed as a conductive plate to which a voltage with a corresponding frequency is applied in order to generate the alternating field in the range of a few megahertz to a few hundred megahertz. A corresponding further conductive element 9, also designed as a conductive plate, is arranged below the lower wall 2.2 with a central region 7.2 also made of glass and forms a capacitor assembly with the heating means 8. The electromagnetic alternating field is thus limited to the region between the heating means 8 and the further conductive element 9.

FIG. 1b shows an embodiment of the cooking appliance 1 substantially corresponding to the embodiment in FIG. 1a in the same view, but with the heating means 8 arranged within the cooking chamber 6 on an inner side of the upper wall 2.1. In this case, the heating means 8 is arranged closer to the food 5 so that the food 5 is better penetrated by the alternating field and the heat radiation acts on the food 5 with a shorter radiation path.

FIG. 2 shows a diagram of a method 10 according to the first aspect of the invention. In a first step 11, an alternating voltage relative to the further conductive element 9 is applied to the heating means 8 in order to generate an electromagnetic alternating field which passes through the cooking chamber 6. The alternating field generates ionic movement as well as rotation of dipolar molecules in the food 5 so that the food 5 is heated evenly. In a second step 12, a current is applied to or generated on the heating means 8 in order to heat the heating means 8 by means of ohmic losses. The thus heated heating means 8 then radiates heat, which heats the surface of the food 5 and cooks it accordingly. The first step 11 and the second step 12 are carried out in continuous alternation, with a change taking place, for example, after a certain time period, approximately in the order of milliseconds or seconds. Alternatively, the time period may also be variable.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Cooking appliance
2 Housing
2.1 Upper wall of the housing
2.2 Lower wall of the housing
2.3 Right wall of the housing
2.4 Left wall of the housing
3 Drawer
3.1 Base of the drawer
4 Placement area
5 Food
6 Cooking chamber
7.1 Central region of the upper wall
7.2 Central region of the lower wall
8 Heating means
9 Further conductive element
10 Method
11 First step of the method—applying an alternating voltage
12 Second step of the method—applying or generating a current

1. A method for operating a heating means of a cooking appliance,
wherein the heating means is made of a conductive material,
wherein the heating means is arranged opposite a further conductive element of the cooking appliance so that a cooking chamber of the cooking appliance extends between the heating means and the further conductive element,
the method comprising:
in an alternating manner, an alternating voltage relative to the further conductive element is applied to or generated on the heating means in order to generate an electromagnetic alternating field which passes through the cooking chamber, and a current is applied to or generated on the heating means in order to heat the heating means by ohmic losses.

2. The method of claim 1, wherein a frequency of the electromagnetic alternating field is between 1 megahertz and 500 megahertz, in particular in an ISM band.

3. The method of claim 1, wherein the current is generated by applying a voltage between two conductor ends of the heating means, in particular at a frequency of 50 or 60 hertz.

4. A cooking appliance for cooking food, comprising:
at least one heating means,
wherein the heating means is made of a conductive material,
wherein the heating means is arranged opposite a further conductive element of the cooking appliance so that a cooking chamber of the cooking appliance extends between the heating means and the further conductive element, and
wherein
the cooking appliance is configured to carry out the method of claim 1.

5. The cooking appliance of claim 4, wherein the heating means and the further conductive element together form a capacitor.

6. The cooking appliance of claim 4, wherein the heating means and/or the further conductive element is/are designed as a plate or flat coil.

7. The cooking appliance of claim 4, designed as a warming drawer assembly.
